(19) United States
(12) Patent Application Publication
(10) Pub. No.: US 2009/0089555 A1
(43) Pub. Date: Apr. 2, 2009

(54) Methods and apparatus for executing or converting real-time instructions

(76) Inventors: James Adam Cataldo, San Jose, CA (US); Jefferson B. Burch, Palo Alto, CA (US); Bruce Hamilton, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/904,831

(22) Filed: Sep. 28, 2007

(51) Int. Cl. G06F 9/30

(52) U.S. Cl. 712/220; 712/E09.032

(57) ABSTRACT

In one embodiment, a computer processor is configured to execute a plurality of instructions defined by an instruction set including at least one real-time instruction. Each of the at least one real-time instruction specifies an execution timing of a respective one of the at least one real-time instruction. Each execution timing is tied to a common real-time measurement system. Other embodiments are also described.

### BACKGROUND

In real-time systems, “when” an instruction is executed is often just as important as “what” instruction is executed. For example, in a stimulus-response measurement system, a measurement device may need to wait a precise amount of time after applying a stimulus before measuring a response.

Unfortunately for real-time systems, the instruction sets of modern computer processors do not provide a way to define when an instruction should be executed. For example, the number of clock cycles that it takes to execute an instruction typically varies, depending on various factors including, for example, whether needed data resides in a cache, and the available bandwidth and latency for accessing main memory. In addition, different computer processors (or even the same computer processor) can operate at different clock speeds, thereby making the length of a clock cycle an “unknown” at the time a computer program is written.

Recently, an attempt was made to bring timing certainty back to embedded processors. See, Ip and Edwards, “A Processor Extension for Cycle-Accurate Real-Time Software”, Proceedings of the IFIP International Conference on Embedded and Ubiquitous Computing”, Seoul, Korea, Aug. 1-4, 2006. As disclosed by Ip and Edwards, a processor may be designed to respond to wait instructions which make the processor wait a particular number of clock cycles before executing a next instruction. However, a problem with wait instructions (also referred to as no-operation instructions, or “no-ops”) is their lack of portability for the purpose of real-time programming. That is, running a computer program on two processors using the same instruction set, but having different clock speeds, will result in a change in program behavior (or will require changes to the number of clock cycles referenced by each wait instruction).

### BRIEF DESCRIPTION OF THE DRAWINGS

Illustrative embodiments of the invention are illustrated in the drawings, in which:

FIG. 1 illustrates exemplary apparatus for executing real-time instructions;

FIGS. 2-4 illustrate various real-time instructions;

FIG. 5 illustrates an exemplary method for executing real-time instructions; and

FIG. 6 illustrates an exemplary method for converting real-time instructions.

### DETAILED DESCRIPTION

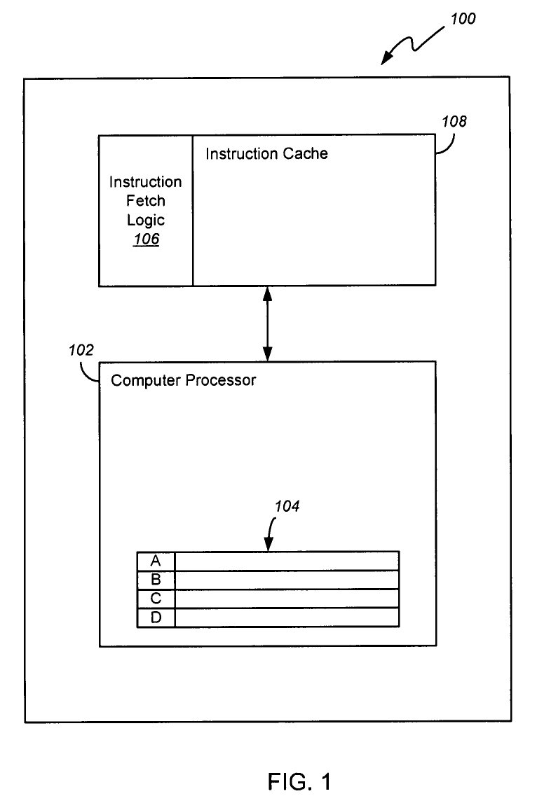

In light of the needs of real-time systems, and other systems that would benefit from the availability of real-time instructions, FIG. 1 illustrates exemplary apparatus 100 comprising a computer processor 102. The apparatus may take various forms, including those of: an integrated circuit package in which the processor 102 is mounted; a computer motherboard to which the processor 102 is connected; a printed circuit board or flex circuit to which the processor 102 is connected; or a computer system in which the processor 102 is installed. The processor 102 may also take various forms, including those of a generic or application-specific processor, and/or those of a personal computer or embedded system processor.

The computer processor 102 illustrated in FIG. 1 is configured to execute a plurality of instructions defined by an instruction set. The instruction set includes at least one real-time instruction, but may also include other types of instructions. Each of the at least one real-time instruction specifies an execution timing of the real-time instruction. Each execution timing is tied to a common real-time measurement system. As defined herein, a “real-time measurement system” is a measurement system that has its basis in “real-time” measurement units, such as a system based on milliseconds, nanoseconds or picoseconds. A real-time measurement system could also be based on “real-time” measurement units such as a number of clock cycles of the processor 102 (i.e., so long as the clock cycles of the processor 102 are substantially uniform and periodic).

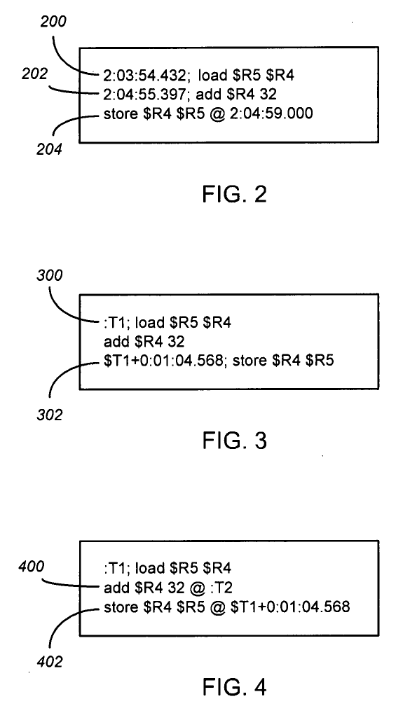

The at least one real-time instruction may take the form of a single or multiple real-time instructions. By way of example, and in some embodiments of the computer processor 102, the at least one real-time instruction may comprise an instruction that specifies an execution timing indicating when execution of the instruction is to be commenced in relation to the start of execution of a computer program. Such an instruction might take the form of “t1; instruction”, where “t1” is the desired time for commencing execution of “instruction”. Two of this type of instruction 200, 202 are illustrated in FIG. 2, where, for example, “2:03:54.432” is the time for commencing execution of “load $R5 $R4”.

Similarly to the instruction described in the preceding paragraph, the at least one real-time instruction could also (or alternately) comprise an instruction that specifies an execution timing indicating when execution of the instruction is to be completed in relation to a start of execution of a computer program. Such an instruction might take the form of “instruction @ t1”, where “t1” is the desired time for completing execution of “instruction”. An instruction 204 of this type may be referred to as a “deadline” instruction and is illustrated in FIG. 2, where, for example, “2:04:59.000” is the time for completing execution of “store $R4 $R5”.

Real-time instructions of other types are also contemplated, such as real-time instructions that specify how long an instruction should take to execute (e.g., “load $R5 $R4=t2”, setting a time limit of t2 for the amount of time to load values $R5 and $R4).

By way of example, the computer program to which an instruction's execution timing is tied may be the same computer program that contains the real-time instruction that is associated with the execution timing. Alternately, the computer program may be a computer program other than the computer program containing the real-time instruction that is associated with the execution timing. The computer program may also take the form of a computer program thread (i.e., when a computer program is configured to be executed by one or more computer processors that execute a plurality of computer program threads in parallel).

In addition to (or instead of) the above instructions, the at least one real-time instruction executed by the computer processor 102 may comprise an instruction that specifies 1) an execution timing indicating when execution of the instruction is to be commenced in relation to an execution timing of another instruction, or 2) an execution timing indicating when execution of the instruction is to be completed in relation to an execution timing of another instruction. A real-time instruction that is to be commenced in relation to an execution timing of another instruction might take the form of “$T1+t1; instruction”, where “t1” indicates a time, after the time stored in register T1, at which the execution of “instruction” is to be commenced. Similarly, a real-time instruction that is to be completed in relation to an execution timing of another instruction might take the form of “instruction @ $T1+t1”, where “t1” is the time, after the time stored in register T1, by which execution of “instruction” is to be completed. Instructions of these types are respectively illustrated by the “store” instruction 302 shown in FIG. 3, and by the “store” instruction 402 shown in FIG. 4. By way of example, the execution timing of the “another instruction” (e.g., the time stored in register T1) may be the commencement timing or the completion timing of the “another instruction”.

In some embodiments, and in addition to one or more real-time instructions, the instruction set of the computer processor 102 may include at least one real-time capture instruction, wherein each of the at least one real-time capture instruction specifies an execution timing to be captured. By way of example, the at least one real-time capture instruction may comprise 1) an instruction that specifies capture of an execution timing indicating when the execution of the instruction is started, or 2) an instruction that specifies capture of an execution timing indicating when the execution of the instruction is completed. A real-time capture instruction designed to capture the execution start time for an instruction might take the form of “:T1; instruction”, indicating that the execution start time for “instruction” should be stored in register T1. See, instruction 300 (FIG. 3). A real-time capture instruction designed to capture the execution completion time for an instruction might take the form of “instruction @:T2”, indicating that the execution completion for “instruction” should be stored in register T2. See, instruction 400 (FIG. 4).

The execution timing(s) specified by one or more real-time capture instructions may be stored by the computer processor 102 in a set of one or more registers 104 (FIG. 1). Similarly, the computer processor 102 or another entity (such as a second computer processor, a timer, or a computer user) may store a recorded event time in the same set of one or more registers 104 (or in a different set). For example, the time at which execution of a computer program starts could be stored in one of the registers. Or, for example, the time at which a certain number of data packets have been sent or received via a network interface could be stored in one of the registers. The same set of one or more registers 104 (or a different set) may also be configured to store an elapsed time since an event. This may be done, for example, by clearing a register upon the occurrence of an event, and then incrementing the register during each clock cycle of the computer processor 102.

The set of one or more registers 104 are shown in FIG. 1 to be implemented within the computer processor 102. However, the register(s) could alternately be implemented externally to the computer processor 102, or the set of one or more registers could be distributed amongst registers that are implemented both internally and externally to the computer processor 102.

In one embodiment, the computer processor 102 may be configured to determine whether to execute a real-time instruction of a first particular type, in accord with an execution timing specified by the real-time instruction of the first particular type, by comparing i) the execution timing specified by the instruction to ii) one of the event times stored in one of the registers 104. If the execution timing specified by the first particular type of real-time instruction is a commencement-type execution timing, the computer processor 102 may delay execution of the instruction until the result of the comparison indicates an appropriate execution commencement. On the other hand, if the execution timing specified by the first particular type of real-time instruction is a deadline-type execution timing, the computer processor may attempt to execute the instruction prior to the execution deadline. The computer processor 102 may also hold off processing other instructions during the period shortly before the instruction is to be executed; and in a multi-core machine, one core may be reserved for this.

In the same or different embodiment described in the preceding paragraph, the computer processor 102 may be configured to determine whether to execute a real-time instruction of a second particular type, in accord with an execution timing specified by the real-time instruction of the second particular type, by comparing i) the execution timing specified by the instruction to ii) an elapsed time stored in one of the registers 104. If the execution timing specified by the particular type of real-time instruction is a commencement-type execution timing, the computer processor 102 may delay execution of the instruction until the result of the comparison indicates an appropriate execution commencement. On the other hand, if the execution timing specified by the particular type of real-time instruction is a deadline-type execution timing, the computer processor may attempt to execute the instruction prior to the execution deadline.

In addition to attempting to ensure compliance with the execution timings specified by real-time instructions, the computer processor 102 may be configured to take particular actions when the execution timing specified by a real-time instruction is missed (e.g., when an execution timing is not met—typically because execution of an instruction is commenced or completed late). In one embodiment, the computer processor 102 may be configured to halt execution of a computer program when an execution timing specified by a real-time instruction is missed. Alternately or additionally, the computer processor may be configured to generate an error indication when the execution timing is missed. In other embodiments, the computer processor 102 may be configured to execute a real-time instruction regardless of whether its execution timing is missed, but may also generate an error indication when the execution timing is missed.

FIG. 1 further illustrates an optional, threaded, “timing aware” instruction cache 106. The instruction cache 106 is coupled to the computer processor 102 and is configured to store instructions for execution by the computer processor 102. The instruction cache 106 comprises instruction fetch logic 108 that is configured to fetch instructions for a plurality of computer program threads, and in response to a determination by the computer processor 102 that an execution timing of a particular real-time instruction has not been reached, suspend, for a period of time, instruction fetch for a computer program thread containing the particular real-time instruction. Instruction fetch may be suspended for a predetermined period of time, or until the computer processor 102 signals that instruction fetch should be resumed.

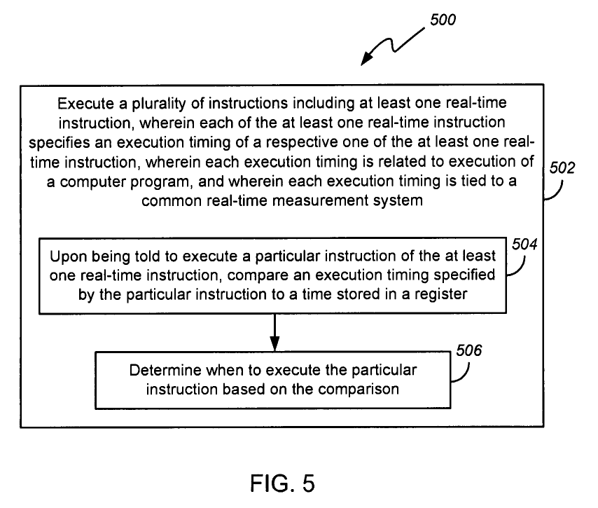

FIG. 5 illustrates an exemplary computer-implemented method 500 that may, for example, be performed by the apparatus 100 shown in FIG. 1. The method 500 comprises executing a plurality of instructions including at least one real-time instruction, wherein each of the at least one real-time instruction specifies an execution timing of a respective one of the at least one real-time instruction, and wherein each execution timing is tied to a common real-time measurement system (at block 502). Upon being told to execute a particular instruction of the at least one real-time instruction, an execution timing specified by the particular instruction is compared to a time stored in a register (at block 504). Based on the comparison, a determination is made regarding when to execute the particular instruction (at block 506). If the execution timing specified by the particular instruction is missed, execution of a computer program may be halted and/or an error indication may be generated.

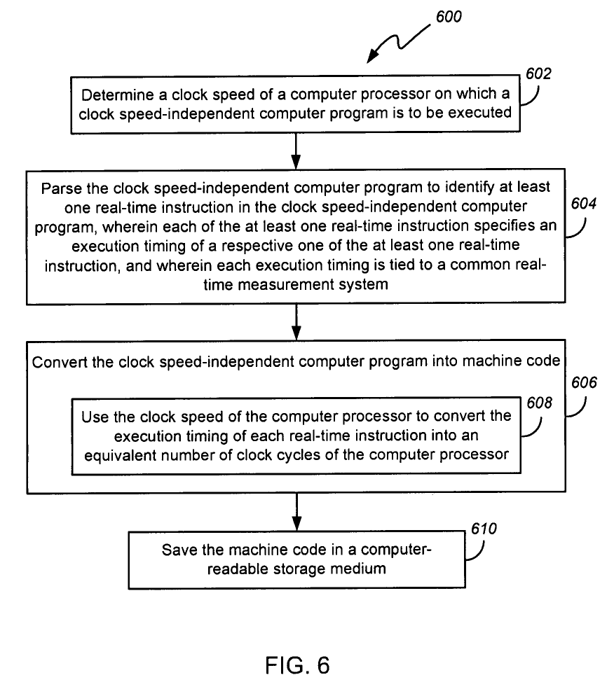

FIG. 6 illustrates an exemplary computer-implemented method 600 for preparing (e.g., assembling or compiling) a clock speed-independent computer program for execution by a computer processor. The method 600 comprises determining a clock speed of a computer processor on which a clock speed-independent computer program is to be executed (at block 602). The clock speed of the computer processor may be determined, for example, by retrieving the clock speed from the computer processor, or by prompting a computer user for the clock speed. The clock speed-independent computer program is then parsed to identify at least one real-time instruction, wherein each of the at least one real-time instruction specifies an execution timing of a real-time instruction, and wherein each execution timing is tied to a common real-time measurement system (at block 604). The clock speed-independent computer program is then converted into machine code (at block 606). As the computer program is converted into machine code, the clock speed of the computer processor is used to convert the execution timing of each real-time instruction into an equivalent number of clock cycles of the computer processor (at block 608). While or after the computer program is converted, the machine code may be stored in a computer-readable storage medium (at block 610).

What is claimed is:

1. Apparatus, comprising:
a computer processor configured to execute a plurality of instructions defined by an instruction set including at least one real-time instruction, wherein each of the at least one real-time instruction specifies an execution timing of a respective one of the at least one real-time instruction, and wherein each execution timing is tied to a common real-time measurement system.

2. The apparatus of claim 1, wherein the at least one real-time instruction comprises an instruction that specifies an execution timing indicating when execution of the instruction is to be commenced in relation to a start of execution of a computer program.

3. The apparatus of claim 1, wherein the at least one real-time instruction comprises an instruction that specifies an execution timing indicating when execution of the instruction is to be commenced in relation to an execution timing of another instruction.

4. The apparatus of claim 1, wherein the at least one real-time instruction comprises an instruction that specifies an execution timing indicating when execution of the instruction is to be completed in relation to a start of execution of a computer program.

5. The apparatus of claim 1, wherein the at least one real-time instruction comprises an instruction that specifies an execution timing indicating when execution of the instruction is to be completed in relation to an execution timing of another instruction.

6. The apparatus of claim 1, wherein the instructions of the instruction set further include at least one real-time capture instruction, wherein each of the at least one real-time capture instruction specifies an execution timing to be captured.

7. The apparatus of claim 6, wherein the at least one real-time capture instruction comprises an instruction that specifies capture of an execution timing indicating when execution of the instruction is commenced.

8. The apparatus of claim 6, wherein the at least one real-time capture instruction comprises an instruction that specifies capture of an execution timing indicating when execution of the instruction is completed.

9. The apparatus of claim 6, further comprising at least one register in which the computer processor stores at least one execution timing specified by the at least one real-time capture instruction.

10. The apparatus of claim 1, further comprising:
at least one register configured to store a captured event time;
wherein the computer processor is configured to determine whether to execute a real-time instruction of a particular type, in accord with an execution timing specified by the real-time instruction of the particular type, by comparing i) the execution timing specified by the real-time instruction of the particular type to ii) one of the event times stored in one of the at least one register.

11. The apparatus of claim 1, further comprising:
at least one register configured to store an elapsed time since an event;
wherein the computer processor is configured to determine whether to execute a real-time instruction of a particular type, in accord with an execution timing specified by the real-time instruction of the particular type, by comparing i) the execution timing specified by the real-time instruction of the particular type to ii) one of the elapsed times stored in one of the at least one register.

12. The apparatus of claim 1, wherein the computer processor is configured to halt execution of a computer program when an execution timing specified by one of the at least one real-time instruction is missed.

13. The apparatus of claim 1, wherein the computer processor is configured to generate an error indication when an execution timing specified by one of the at least one real-time instruction is missed.

14. The apparatus of claim 1, further comprising:
an instruction cache coupled to the computer processor, the instruction cache being configured to store instructions for execution by the computer processor; and
instruction fetch logic configured to fetch instructions for a plurality of computer program threads, and in response to a determination by the computer processor that an execution timing of a particular real-time instruction has not been reached, suspend, for a period of time, instruction fetch for a computer program thread containing the particular real-time instruction.

15. The apparatus of claim 1, wherein each execution timing is expressed as a number of clock cycles of the computer processor.

16. A computer-implemented method, comprising:
executing a plurality of instructions including at least one real-time instruction, wherein each of the at least one real-time instruction specifies an execution timing of a respective one of the at least one real-time instruction, wherein each execution timing is related to execution of a computer program, and wherein each execution timing is tied to a common real-time measurement system;
upon being told to execute a particular instruction of the at least one real-time instruction, comparing an execution timing specified by the particular instruction to a time stored in a register; and
determining when to execute the particular instruction based on the comparison.

17. The method of claim 16, further comprising, when the execution timing specified by the particular instruction is missed, generating an error indication.

18. The method of claim 16, further comprising, when the execution timing specified by the particular instruction is missed, halting execution of a computer program.

19. A computer-implemented method, comprising:
determining a clock speed of a computer processor on which a clock speed-independent computer program is to be executed;
parsing the clock speed-independent computer program to identify at least one real-time instruction in the clock speed-independent computer program, wherein each of the at least one real-time instruction specifies an execution timing of a respective one of the at least one real-time instruction, and wherein each execution timing is tied to a common real-time measurement system; and
converting the clock speed-independent computer program into machine code, including using the clock speed of the computer processor to convert the execution timing of each real-time instruction into an equivalent number of clock cycles of the computer processor; and
saving the machine code in a computer-readable storage medium.

20. The method of claim 19, wherein the clock speed of the computer processor is determined by retrieving the clock speed from the computer processor.
